(19) United States
(12) Patent Application Publication
(10) Pub. No.: US 2005/0000315 A1
(43) Pub. Date: Jan. 6, 2005

(54) Rotational movement amplifying apparatus

(76) Inventor: Dug Gum Lee, Los Angeles, CA (US)

Correspondence Address: Jerry H. Noh, Suite 2741, 3435 Wilshire Blvd, Los Angeles, CA, 90010, US

(21) Appl. No.: 10/610,958

(22) Filed: Jul. 1, 2003

(51) Int. Cl. F16H 33/00

(52) U.S. Cl. 74/572

(57) ABSTRACT

An apparatus for amplifying the rotational force of a rotating object comprising a housing member having a chamber defined therein and a rotational unit placed within the chamber. The rotational unit comprising an elongated member having one or more rods placed transversely through the elongated member. The elongated member being mounted off-centered within the chamber in a manner to allow for rotation thereof. The chamber being sized and shaped so that as the elongated member rotates, the rods slide and rotate along its respective axis and imparts additional rotational force to the rotation of the elongated member.

### BACKGROUND OF THE INVENTION

1. Field of the Invention

This invention generally relates to an apparatus for amplifying the rotational movement of rotating devices. More particularly the apparatus of the present invention relates to an apparatus which amplifies the rotational movement of rotating devices such windmills, wheels, propellers, axle of wheels, and so on.

2. Description of the Prior Art

There are many different types of rotating devices. Examples of rotating devices include windmills, wheels, propellers, axle for wheels, motor gears, and so on. For windmills, the power to turn the blades of the windmill comes from wind hitting the blades at the proper angle. The wind must continually blow onto the blades to continue the rotation of the blades. For wheels, examples include from bicycle wheels, motorcycle wheels, to ferris wheels. For bicycles, power for rotation of the wheels derives from manual leg power pushing the pedals, and for motorcycles and ferris wheels, power for rotation comes from battery or electric powered motors.

For generating rotational force for rotating devices, power must come from sources such as manual, leg powered, battery, electric, wind, solar, and so on. It is desirable that the least amount of power from the power source be used for generation of the rotation of the rotating device. There are known ways to lower the amount of power utilized from the power source, which can include modification of the design of the rotating device, varying the weight of the rotating devices, and varying the structure of the rotating device. In a U.S. Pat. No. 3,885,814 issued to Rizzo, a bicycle is taught having a wheel specially weighted with weights which are slidably attached to the spokes of the wheel and are spring biased to move between an extended and a retracted position depending on the rate of rotation of the wheel. These weights are placed on the wheel to afford enhanced momentum, stability, and reduce human pedal power for continual rotation at high rates of speed.

None of the prior art teaches an apparatus as taught by the present invention. The apparatus of the present invention generates rotational force utilizing gravitational forces. The apparatus of the present invention can be coupled with rotating devices to reduce the power necessary to rotate the rotating portions of these rotating devices.

Thus, it is an object of the present invention to provide an apparatus which generates rotational force. it is another object of the present invention to provide an apparatus which provides amplification of rotational force to rotating devices. It is yet another object of the present invention to reduce the usage of power necessary to rotate devices.

### SUMMARY OF THE INVENTION

The present invention is an apparatus for amplifying the rotational force of a rotating object. The apparatus comprises a housing member having a chamber defined therein and a rotational unit placed within the chamber. The rotational unit comprises an elongated member having one or more rods placed transversely through the elongated member. In the embodiment shown, a plurality of holes are placed through the elongated member for placement of a corresponding rod therethrough. The elongated member is mounted within the chamber in a manner to allow for rotation thereof. As the elongated member rotates within the chamber, each rod rotates along an axis transverse to the elongated member and slides back and forth within the corresponding hole. As each rod rotates within its axis, the ends make contact with the interior surface of the housing member. The ends of each rod are designed for least friction with the interior surface of the housing member within the chamber.

The chamber of the apparatus is generally cylindrical and has a transverse cross-sectional shape in the form of a circle having a slightly elongated central section. The chamber is sized and shaped corresponding to the rotation of the rotational unit. The elongated member is mounted in an off-centered position relative to a center of an end of the chamber.

As the elongated member rotates, the rods slide and rotate along its respective axis and imparts additional rotational force to the rotation of the elongated member. The elongated member can be coupled to a rotating device to provide amplification of the rotational force to the rotating device.

### BRIEF DESCRIPTION OF THE DRAWINGS

FIG. 1 is a perspective view of the present apparatus coupled to a windmill;

FIG. 2 is a side cross-sectional view of the present invention;

FIG. 3 is an isolated perspective view of the rotational unit of the present invention;

FIG. 4 is a top cross-sectional view of the present invention; and,

FIG. 5 is a diagram illustrating the transverse cross-sectional shape of the interior surface defining the chamber from FIG. 2.

### DETAILED DESCRIPTION OF THE PREFERRED EMBODIMENT

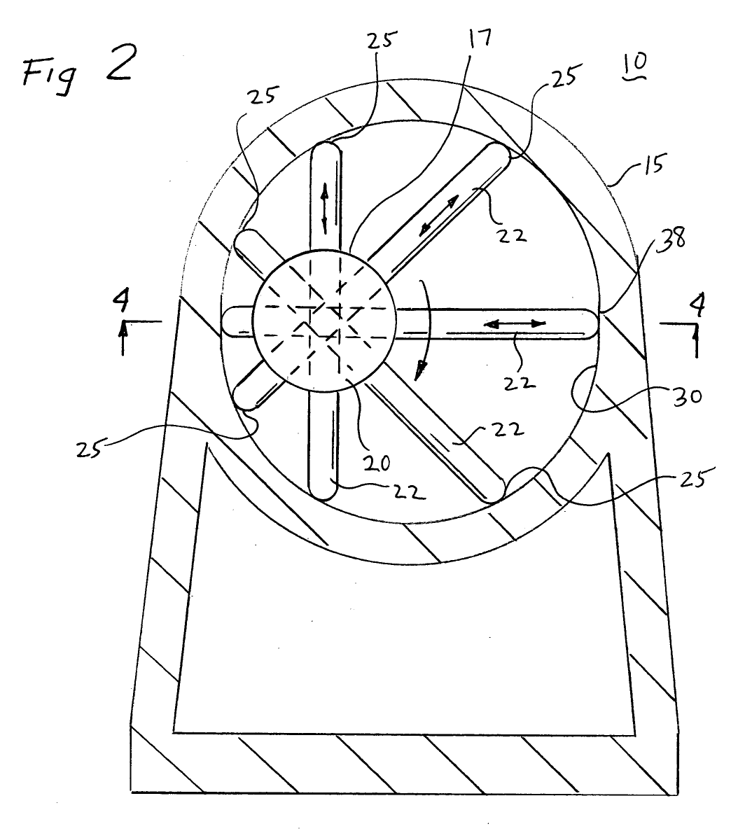

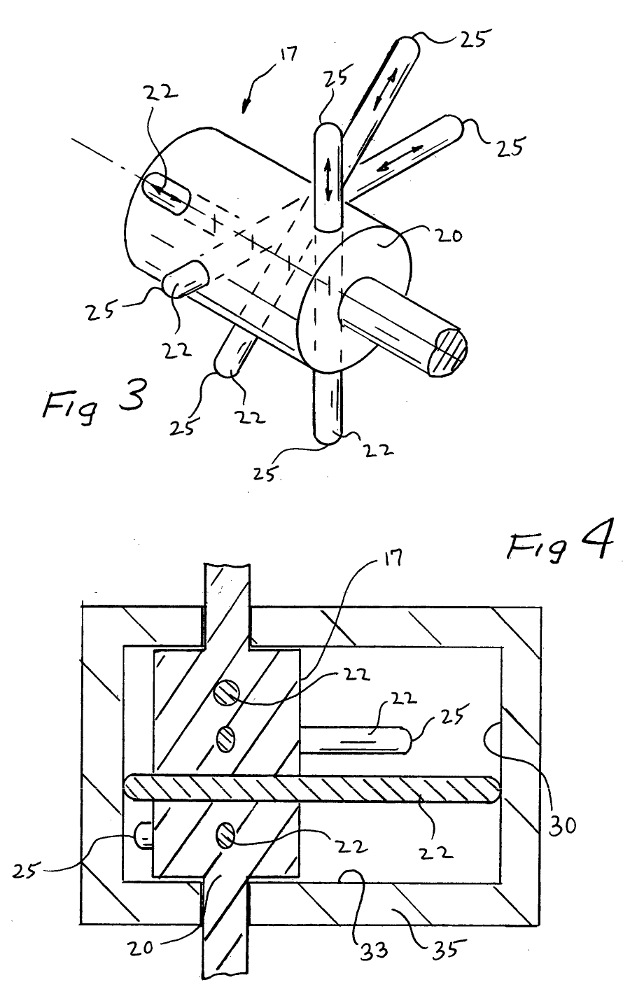

The present invention illustrated in FIGS. 2 to 5 is an apparatus 10 for amplifying rotational movement of miscellaneous rotating objects. The apparatus 10 comprises a housing member 15 as shown in FIG. 2 having a chamber defined therein. In addition, a rotational unit 17 is placed within the chamber of the housing member 15. FIG. 2 shows a cross-sectional side view of the apparatus 10, and FIG. 3 shows an isolated perspective view of the rotational unit 17. As shown in FIGS. 2 to 4, the rotational unit 17 comprises an elongated member 20 extending longitudinally through the chamber of the housing member 15 and at least one rod 22 placed transversely through the elongated member 20. The elongated member 20 is mounted to allow for rotation thereof. Although the elongated member 20 as shown in the present illustration is solid, the elongated member 20 can be tubular. The desired effect will be produced with at least one rod 22; however, for increased utility, two or more rods 22 are preferred. For purposes of illustration, an embodiment utilizing four rods 22 is shown and described herein. For maximum result, each rod 22 is of uniform size, shape, and length relative to each other. In addition, each rod 22 is of a uniform density throughout the length. The ends 25 of each rod 22 should be designed for least friction with the interior surface 30 of the housing member 15 within the chamber. As such, the ends 25 of the rod 22 can be tapered to have a sharp tip, or have a rounded tip as shown in the illustrations. In the alternative, the ends 25 of the rod 22 can have a bearing mounted at the tip thereof (not shown). The rods 22 are placed through the elongated member 20 so that each rod 22 can slide freely therethrough. To effectuate the sliding motion, in the illustrations shown, each rod is placed through a corresponding hole extending through the elongated member 20. In the embodiment shown, the holes are positioned along the length of the elongated member 20 so that the rods 22 are arranged in a staggered formation. In the embodiment shown, each rod 22 rotates along an axis parallel to the rotational axis of the adjacent rods 22.

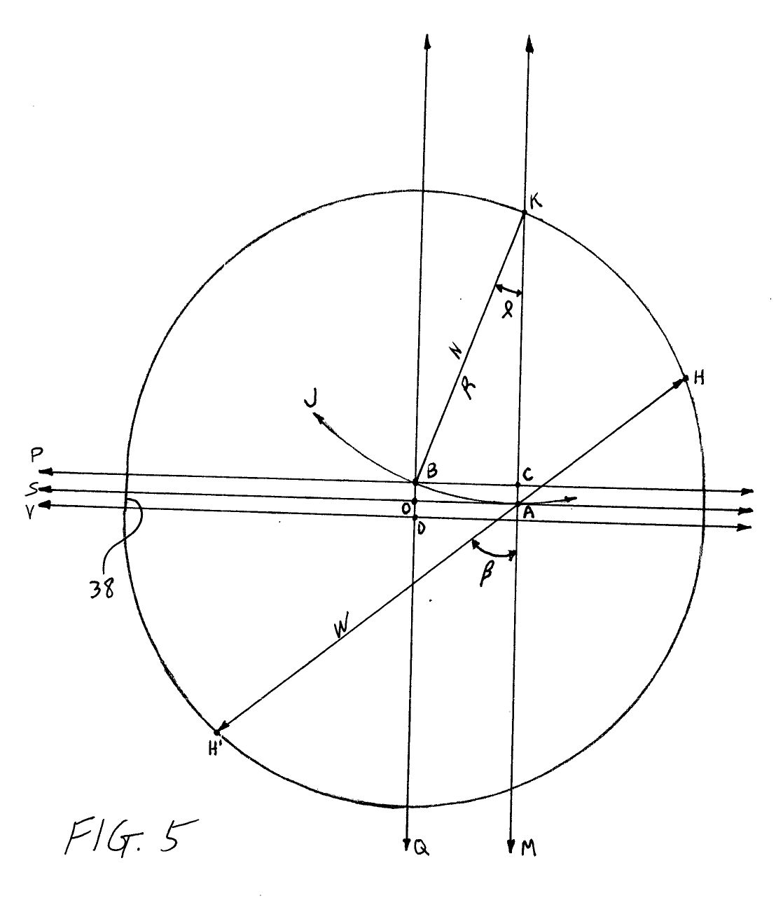

The exterior surface shape of the housing member 15 is not a limiting factor and as such need not be in any particular shape; however, the chamber defined therein must be sized and shaped corresponding to the rotation of the rotational unit 17. As shown in FIG. 2, the interior surface 30 of the housing member 15 defining the chamber has a transverse cross-section shaped in the form of a circle having a slightly elongated central section. As shown in FIG. 2 and 4, the elongated member 20 is positioned off-centered relative to a center 33 of the end 35 of the chamber.

FIG. 5 illustrates the transverse cross-sectional shape of the interior surface 30 defining the chamber from FIG. 2. As shown, the shape is essentially two semi-circles of radius R, separated by a central section 38 having a length twice the distance of the distance between point A and point C. Point O is the center of the end of the shape shown in FIG. 5, and point A is the desired center point on which the elongated member should be mounted for rotation within the chamber. The shape shown in FIG. 5 is made first by selecting a random point identified in this figure as K. Thereafter an arc J having a predetermined radius R is drawn with point K as the center. A line M is drawn from K through the arc J to form point A. Line N is drawn from point K through the arc to form an angle a with line M and to form a point B with the arc J. Line P is drawn through point B perpendicular to line M to form point C at the intersection between lines M and P. Line Q is drawn through point B perpendicular to line P. Line S is drawn through point A perpendicular to line M to form point O at the intersection between lines Q and S. The distance between point B and O is taken along line Q from point O to find point D on line Q. Line V is drawn through point D perpendicular to line Q. With B as the center, a semicircle of radius R is drawn to form the upper half of the shape, and with D as the center, a semicircle of radius R is drawn to form the lower half of the shape. The diameter of the shape going through point A as shown in FIG. 5 line W varies according to the angle β formed between line W and line M. The largest diameter has been found to be formed when β is 55 degrees. The smallest diameter has been found to be formed when β is 0 degrees. It is desired that the difference between the largest and smallest diameter distance going through point A be minimal, and this difference in distance is determined by the size of angle α. As such, a shape of the chamber formed from an angle α having a range between 21 to 26 degrees provides an ideal minimal diameter range. For the smallest difference in diameter going through point A, an angle α of 23 degrees should be used as shown in the following computations in Table 1 and Table 2.

TABLE 1

| angle α (degrees) | OA (m) | OB (m) |
|---|---|---|
| 20 | 17.1 | 3.02 |
| 21 | 17.9 | 3.32 |
| 22 | 18.75 | 3.62 |
| 23 | 19.55 | 3.975 |
| 24 | 20.35 | 4.325 |
| 25 | 21.30 | 4.685 |
| 26 | 21.90 | 5.06 |
| 27 | 22.70 | 5.45 |
| 28 | 23.45 | 5.85 |
| 30 | 25 | 6.70 |

For Table 1, a radius R of 50 meters was utilized. Next, using the OA and OB values from angle α of 23 degrees, various diameter distances through point A were calculated according to various angle β.

TABLE 2

| Angle β | | | Total HH′ |
|---|---|---|---|
| (degrees) | AH (m) | AH′ (m) | (AH + AH′) |
| 0.00 | 50.00 | 50.00 | 100.00 |
| 19.91 | 43.02 | 57.41 | 100.43 |
| 40 | 37.32 | 64.05 | 101.37 |
| 55 | 34.11 | 67.66 | 101.77 |
| 70 | 31.86 | 69.66 | 101.52 |

According to Table 2, the largest diameter going through point A is found at angle β of 55 degrees, and the smallest diameter is found at angle β of 0 degrees.

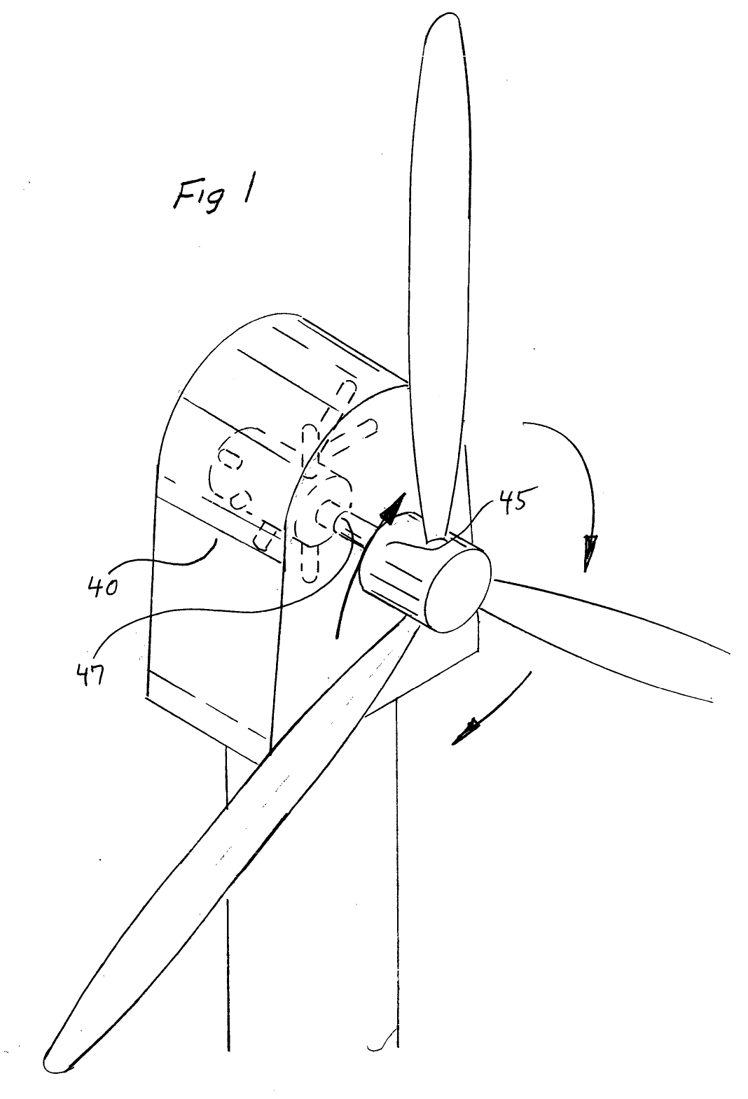

The present invention can be coupled with most devices which have a rotational movement for enhancement of the rotational force of the rotating component. As shown in FIG. 1, the apparatus is coupled to the rotating blade of a windmill. FIG. 1 illustrates just one of many other rotating devices the present apparatus can be coupled to in order to provide amplification of the rotating movement. For instance, other rotating devices can include, wheels, mills, propellers, mills, and so on. For use with rotating devices, a frame 40 coupled to the rotating device 45 houses the apparatus of the present invention.

In use, rotation of the elongated member 20 causes each rod 22 to slide back and forth through the corresponding hole of the elongated member 20. The rod 22 utilizes gravitational downward forces created by the imbalanced position of the rod 22 generated in different rotational positions during a rotational cycle as shown in FIG. 2. This imbalanced position is created by the sliding motion of the rod 22 and the off-centered position of the elongated member 20. With the staggered position of the rods 22 along the elongated member 20, as one rod 22 pulls downward, another rod 22 follows with an additional downward pull, followed by another downward pull, and this cycle continues with each successive rod 22 and repeats thereafter. With each downward pull, rotational force is provided for rotation of the elongated member 20, which when coupled to a rotating device 45, provides amplification of the rotational force of that rotating device 45. In FIG. 1, an end 47 of the elongated member 20 is connected to the rotating device 45.

Although a preferred embodiment of the invention has been described and illustrated for purposes of clarity and example, it should be understood that many changes, substitutions and modifications to the described embodiment will be apparent to those having skill in the art in light of the foregoing disclosure without departing from the scope and spirit of the present invention which is defined by the claims which follow.

1. A rotational movement amplifying apparatus comprising:
a housing member defining a chamber therein, said chamber being generally cylindrical;
an elongated member rotationally mounted onto said housing member to extend longitudinally through said chamber; and,
one or more rods slideably disposed transversely through said elongated member.

2. An apparatus as described in claim 1 comprising two or more rods, wherein said rods are arranged in a staggered formation along said elongated member.

3. An apparatus as described in claim 1 wherein said elongated member is positioned off-centered relative to a center of an end of said chamber.

4. An apparatus as described in claim 1 wherein said interior surface of said housing member defining said chamber has a transverse cross-section shaped in the form of a circle having a slightly elongated central section.

5. A rotational movement amplifying apparatus comprising:
a frame coupled to a rotating device;
a chamber barreled within said frame;
an elongated member rotationally mounted onto said frame to extend longitudinally through said chamber;
said elongated member having an end connected to said rotating device; and,
one or more rods slideably disposed transversely through said elongated member.

6. An apparatus as described in claim 5 comprising two or more rods, wherein said rods are arranged in a staggered formation along said elongated member.

7. An apparatus as described in claim 5 wherein said elongated member is positioned off-centered relative to a center of an end of said chamber.

8. An apparatus as described in claim 5 wherein said barreled interior surface of said frame surrounding said chamber has a transverse cross-section shaped in the form of a circle having a slightly elongated central section.
